(19) United States
(12) Patent Application Publication
(10) Pub. No.: US 2025/0351203 A1
(43) Pub. Date: Nov. 13, 2025

(54) METHOD FOR ESTABLISHING COMMUNICATION BETWEEN AT LEAST TWO APPARATUSES IN A COMMUNICATION NETWORK

(71) Applicant: Orange, Issy-Les-Moulineaux (FR)

(72) Inventors: Xavier MARJOU, Chatillon Cedex (FR); Benoit RADIER, Chatillon Cedex (FR); Gaël FROMENTOUX, Chatillon Cedex (FR)

(21) Appl. No.: 18/872,756

(22) PCT Filed: Jun. 2, 2023
(86) PCT No.: PCT/EP2023/064805

§ 371 Date: Dec. 6, 2024

(30) Foreign Application Priority Data
Jun. 9, 2022 (FR) FR2205553

(51) Int. Cl. H04W 76/10; H04L 41/16; H04W 4/12

(52) U.S. Cl. CPC H04W 76/10; H04L 41/16; H04W 4/12

(57) ABSTRACT

A method for establishing communication between at least two apparatuses in a communication network. Such a method includes, in an intermediate device: receiving, from one of the two apparatuses, referred to as first apparatus, a first message which is formatted in a first language associated with the first apparatus; generating, from the first message, a second message which is formatted in a second language associated with the other one of the two apparatuses, referred to as second apparatus, the second message corresponding to a translation of the first message into the second language, the generation being implemented by means of at least one artificial neural network; and transmitting the second message to the second apparatus.

### CROSS-REFERENCE TO RELATED APPLICATIONS

This application is filed under 35 U.S.C. § 371 as the U.S. National Phase of Application No. PCT/EP2023/064805 entitled “METHOD FOR ESTABLISHING COMMUNICATION BETWEEN AT LEAST TWO APPARATUSES IN A COMMUNICATION NETWORK” and filed Jun. 2, 2023, and which claims priority to FR 2205553 filed Jun. 9, 2022, each of which is incorporated by reference herein in its entirety.

### BACKGROUND

### Field

The development lies in the field of communication networks. More particularly, the development relates to the administration and supervision of apparatuses used for the implementation of such networks.

### Description of the Related Technology

A communication network is generally based on an infrastructure comprising numerous apparatuses of various origins and types, which the network operator must be able to administer and supervise, for example in order to quickly detect possible malfunctions or optimization options and to be able to intervene accordingly in order to ensure optimal operation of the network. To this end, an operator can in particular collect and monitor numerous metrics reported by these apparatuses, for example in the form of predefined key performance indicators (also called KPIs). If necessary, an operator can also send instructions to an apparatus in order to temporarily or permanently modify its configuration.

In addition to the presence of different apparatuses to provide various functions, it is common for apparatuses of the same type but from different apparatus manufacturers to be implemented within the same communication network, for example for reasons of cost, hardware redundancy intended to make the network more robust, network deployment history, etc. This hardware diversity is not without raising certain problems for the operator: not only is it likely to constitute a brake on the interoperability of these different apparatuses, but it also significantly complicates the supervision, administration and configuration of the communication network. Indeed, each apparatus manufacturer tends to implement its own system of metrics and commands, when it comes to providing a user (typically an operator) with the tools to manage the apparatuses it markets. Thus, metrics (that is to say indicators) of the same type for apparatuses of the same type but from different apparatus manufacturers are often named differently (for example, the same indicator is named “VS.DLPRBUsedPerTypeService.VolPGBR.Cum” for one apparatus manufacturer and “DLPR-BUSEDPTYPESERV_VOIPGBR_CUM” for another apparatus manufacturer), or even associated with different value formats (for example, the same indicator is returned in the form of an integer for one apparatus manufacturer, and a relative number for another apparatus manufacturer). The same applies to the commands made available to modify the configuration of these apparatuses, which, from one apparatus to another, are likely to have not only different names for similar functions, but also to accept parameters of different formats. Added to this already significant heterogeneity is the fact that the operator generally has its own nomenclature and format system, different from those of its apparatus manufacturers, with regard to these indicators or commands, which further complicates network administration and supervision operations.

To address these issues, standardization work has been undertaken, particularly by certain organizations such as 3GPP (“3rd Generation Partnership Project”) and ETSI (“European Telecommunications Standards Institute”) in the field of telecommunication networks. Despite these standardization attempts, operators and apparatus manufacturers have not managed to converge towards the use of a standard for the nomenclature and format of data related to the configuration and administration of networks. Moreover, the proposals and additional recommendations formulated by these organizations in this field remain little adopted and little implemented by the various actors involved.

As a result, an operator is generally forced to develop and maintain mediation interfaces, based on software code, in order to be able to consolidate in its own information system the indicators sent back from the various apparatuses in its communication network, or to send configuration messages to these apparatuses. Given the frequent developments of a communication network (deployment of the network with more recent hardware and/or software, replacement of obsolete apparatuses, upgrade of certain apparatuses, etc.), this software code must be constantly reviewed and updated, and its complexity increases over time. For example, the integration of a new apparatus into the operator network requires the operator to develop and integrate the software code necessary to, on the one hand, translate the indicators sent in the telemetry messages emitted by the apparatus from a proprietary language specific to the apparatus manufacturer to the proprietary language specific to the operator, and on the other hand, translate the commands transmitted in the configuration messages emitted by the operator from the proprietary language specific to the operator to the proprietary language specific to the apparatus manufacturer. Such operations are generally not limited to a simple renaming of the names of the indicators and commands, but often require complex aggregation and adaptation manipulations (an indicator on the operator side may, for example, correspond to the sum of a plurality of indicators on the apparatus manufacturer side, with different data formats).

The development and maintenance of the software code implemented at these mediation interfaces are therefore proving to be increasingly tedious and costly, with an increasing risk of errors, given the high number and variety of apparatuses integrated into current communication networks.

There is therefore a need for a solution to simplify the administration and supervision of the numerous heterogeneous apparatuses in a communication network, and more generally to facilitate overall interoperability between these different apparatuses.

### SUMMARY

The present technique allows to propose a solution aiming at overcoming certain disadvantages of the prior art. According to one aspect, the present technique indeed relates to a method for establishing a communication between two apparatuses in a communication network. Such a method comprises, in an intermediate device, at least one iteration of the following steps for the implementation of said communication: receiving, from one of said two apparatuses, referred to as first apparatus, a first message which is formatted in a first language associated with said first apparatus; generating, from said first message, a second message which is formatted in a second language associated with the other one of said two apparatuses, referred to as second apparatus, said second message corresponding to a translation of said first message into said second language, said generation being implemented by means of at least one artificial neural network; transmitting said second message to said second apparatus.

In this way, it is no longer necessary to resort to the tedious and complex operations of developing and maintaining a conversion code between different communication languages at mediation interfaces to allow the implementation of communication between apparatuses associated with different communication languages.

In a particular embodiment, said first message is a message associated with a telemetry task, said first message comprising at least one name and one value associated with at least one indicator sent back by said first apparatus, said at least one indicator being associated with an operating state of said first apparatus and/or said communication network.

In this way, the present technique allows in particular easy management of the operations of collecting and monitoring metrics sent back by the first apparatus, and in particular of key performance indicators related to the first apparatus and/or to the communication network.

According to a particular feature of this embodiment, said second message comprises at least a translation of said name into said second language and/or a conversion of said value into a corresponding indicator value format of said second language.

In this way, the present technique allows an automatic conversion of the metrics sent back by the first apparatus (typically an apparatus from an apparatus manufacturer) into a format directly usable by the second apparatus (typically an apparatus from an operator).

In a particular embodiment, said first message is a message associated with a configuration task, said first message comprising at least one configuration modification instruction emitted by said first apparatus to said second apparatus.

In this way, the present technique allows in particular easy management of configuration operations, for example by an operator, of the apparatuses of a communication network.

According to a particular feature of this embodiment, said second message comprises at least one translation of said instruction into said second language and/or a conversion of at least one parameter associated with said instructions into a corresponding configuration parameter format of said second language.

In this way, the present technique allows an automatic conversion of the configuration instructions emitted by the first apparatus (typically an operator apparatus) into a format directly understandable and executable by the second apparatus (typically an apparatus from an apparatus manufacturer).

In a particular embodiment, said at least one artificial neural network is a transformer-based network.

In this way, the prospects of obtaining optimal performances for the translation of the first language into the second language are maximized, since transformer-based networks, and in particular autoregressive networks, have already proven themselves in contexts of automatic translations from one language to another for languages spoken by human speakers.

In a particular embodiment, said at least one artificial neural network is trained by learning, by means of at least one learning base comprising a plurality of samples associating in this order input data formatted in said first language with target data formatted in said second language, said target data corresponding to a translation of said input data into said second language.

In this way, with the proposed technique, the business logic is managed at one or more learning bases rather than at a complex and difficult to maintain conversion software code, which offers many advantages in terms of simplicity and flexibility, particularly for taking into account developments in the communication network.

In a particular embodiment, for each sample of said plurality of samples, said at least one learning base comprises a sample called a mirror sample associating in this order said target data formatted in said second language with said input data formatted in said first language.

In this way, a learning base allowing to train artificial neural networks to support bidirectional or multidirectional translations is easily built, by simple duplication of samples with inversion of the input data and the target data.

In a particular embodiment, said at least one learning base further comprises a plurality of samples associating data formatted in said first language and/or said second language with translated data formatted in at least one other language different from said first language and said second language.

In this way, the present technique allows to manage a “multilingual” context, with translations from at least one language to several other languages being able to be implemented by the same intermediate device.

In a particular embodiment, said samples comprise at least one association between: at least one indicator name and one indicator value format in said first language with at least one corresponding indicator name and one corresponding indicator value format in said second language; and/or at least one configuration command name and one configuration parameter format in said first language with at least one corresponding configuration command name and one corresponding configuration parameter format in said second language.

In this way, a learning base for training a neural network to handle telemetry and/or configuration tasks is easily built.

In a particular embodiment, a specific indicator and/or parameter value in said input data is respectively representative of an absence of a corresponding indicator and/or parameter in said target data.

In this way, the user has a way to indicate that an indicator or parameter has no equivalent in a target language, or that it should not be translated.

In a particular embodiment, said samples further comprise, in at least one of said input data and said target data, information belonging to the group comprising: an actor identifier associated with an apparatus; an apparatus identifier; an apparatus version; a software identifier associated with an apparatus; a software version associated with an apparatus; a timestamp; a type of task.

In this way, various complementary data are present in the samples of the training base, in order to complete or facilitate the learning of the neural network.

In a particular embodiment, said information is preceded by a prefix identifying the associated type of information, said prefix being, for a given type of information, constant throughout said learning base.

In this way, the detection of this additional information by the neural network is facilitated, and the learning task is further simplified.

According to another aspect, the present technique also relates to a device for establishing communication between two apparatuses in a communication network. Such a device comprises: means for receiving, from one of said two apparatuses, referred to as first apparatus, a first message which is formatted in a first language associated with said first apparatus; means for generating, from said first message, a second message which is formatted in a second language associated with the other one of said two apparatuses, referred to as second apparatus, said second message corresponding to a translation of said first message into said second language, said generation being implemented by means of at least one artificial neural network; means for transmitting said second message to said second apparatus.

According to another aspect, the proposed technique also relates to a computer program product downloadable from a communication network and/or stored on a computer-readable medium and/or executable by a microprocessor, comprising program code instructions for executing a method for establishing communication between two apparatuses of a communication network as described above, when executed on a computer.

The proposed technique also relates to a computer-readable recording medium on which is recorded a computer program comprising program code instructions for executing the steps of the method as described above, in any of its embodiments.

Such a recording medium may be any entity or device capable of storing the program. For example, the medium may include a storage medium, such as a ROM, for example a CD ROM or a microelectronic circuit ROM, or a magnetic recording medium, for example a USB key or a hard disk.

On the other hand, such a recording medium may be a transmissible medium such as an electrical or optical signal, which can be conveyed via an electrical or optical cable, by radio or by other means, so that the computer program contained therein is remotely executable. The program according to the development may in particular be downloaded over a network, for example the Internet network.

The various embodiments mentioned above can be combined with each other for the implementation of the development.

### BRIEF DESCRIPTION OF THE DRAWINGS

Other features and advantages of the development will appear more clearly upon reading the following description of a preferred embodiment, given as a simple illustrative and non-limiting example, and the appended drawings, among which:

FIG. 1 illustrates the general principle of a method for establishing communication between two apparatuses in a communication network, in a particular embodiment of the proposed technique;

FIG. 2 shows some samples of a learning base capable of being used to train at least one artificial neural network to translate a message from one language to another, in a particular embodiment of the proposed technique;

FIG. 3 describes a simplified architecture of an intermediate device for implementing the proposed technique, in a particular embodiment.

### DETAILED DESCRIPTION OF CERTAIN ILLUSTRATIVE EMBODIMENTS

This application addresses some of the above-mentioned disadvantages.

The proposed technique aims in particular at proposing a simpler, less expensive and more flexible solution than the development and maintenance of mediation software interfaces according to the prior art—which generally rely on “raw” (that is to say “hard”) coding of translation rules—for establishing communication between potentially heterogeneous apparatuses (for example because they come from different apparatus manufacturers) within a communication network.

In this document, the proposed technique is mainly presented in the context of exchanging telemetry and configuration messages between network apparatuses forming at least part of the infrastructure of a telecommunication network (for example a 3G, 4G or 5G network). It is understood that this example is purely illustrative and non-limiting, and representative of a particular embodiment of the proposed technique. In particular, the present technique can be implemented in other contexts, comprising exchanges of messages relating to other types of tasks than telemetry or configuration tasks.

The term “language associated with an apparatus” (or, by extension, “language specific to an apparatus manufacturer”) is hereinafter understood to mean a set of syntax, nomenclature (of data such as indicators, functions, etc.) and format rules which is expected and/or used by a network apparatus in its communications with third-party apparatuses. By analogy with human speakers, this is the “language” spoken and understood by the network apparatus, that is to say the communication language wherein it delivers information or commands to other apparatuses and wherein it is able to understand information or commands received from other apparatuses. The present technique thus relates to translation solutions allowing to establish communication between network apparatuses that do not necessarily share the same language.

In all figures of this document, identical elements and steps are designated by the same reference numeral. Moreover, in the description which follows, the terms “first” and “second” (used to qualify an apparatus, a message, a language, etc.) are intended only to allow a distinction to be made between two elements, and in no way imply the existence of any order relationship between these elements.

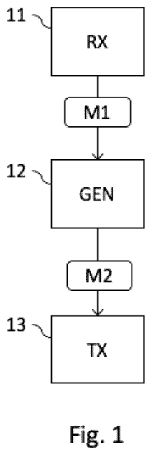

According to a first aspect, the present technique relates to a method for establishing a communication between two apparatuses in a communication network: a first apparatus associated with a first communication language and a second apparatus associated with a second communication language (generally different from the first communication language). The first language and the second language may differ in that the messages and/or the attributes and/or the values of the respective languages are different. The general principle of such a method is illustrated in relation to FIG. 1, in a particular embodiment of the proposed technique. This method is implemented in an intermediate device, that is to say at a device capable of relaying any communication or any message relating to the communication from one of the two apparatuses to the other of the two apparatuses (and vice versa), where appropriate by adapting them. Such an intermediate device may be comprised in a third-party apparatus distinct from the two apparatuses between which it is intended to establish a communication. Alternatively, the intermediate device may be embedded within either one of these two apparatuses, for example within a communication interface of the concerned apparatus.

In a step 11, the intermediate device receives a message M1 from the first apparatus of the communication network. Such a message comprises data formatted in the language associated with said first apparatus, that is to say in the first communication language.

In a step 12, the message M1 received in step 11, called the first message, is provided as input to at least one artificial neural network previously trained to translate data from at least one language, and more particularly from the first language associated with the first apparatus, to at least one other language, and more particularly to the second language associated with the second apparatus. This neural network processes the first message M1, and generates as output a second message M2 corresponding to a translation of the first message M1 into the second language associated with the second apparatus.

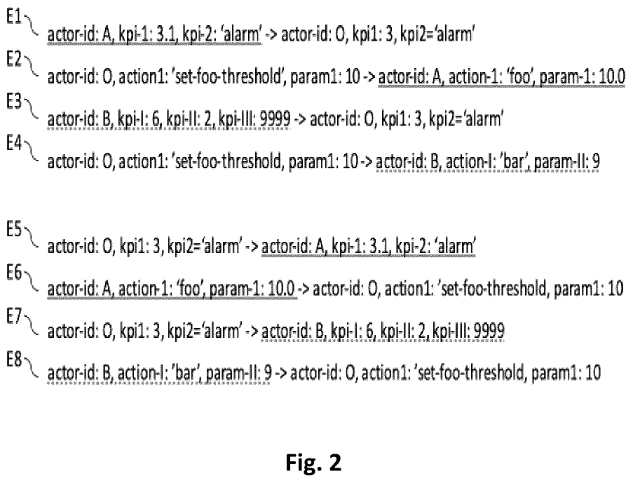

In a particular embodiment, the neural network used is a transformer-based neural network. According to a particular feature, the model of the neural network is more particularly of the “pure decoder” type (for example GPT model, from “Generative Pre-Training”): only the decoder part of the transformer-based neural network is retained. Such a model, called autoregressive, is interesting in that it has already proven itself for the implementation of automatic translations from one language to another (for example from French to German), with regard to languages spoken by human speakers. The proposed technique is however not limited to the “decoder” type model, and other transformer-based neural network models, for example of the “encoder-decoder” type (for example T5 or mT5 models), or of the “pure encoder” type (for example BERT model, from “Bidirectional Encoder Representations from Transformers”) can also be used within the framework of the present technique. It should be noted that it is not simply a question of using a technique or a tool (such as for example the GPT model) for a context other than (network supervision) the initial context (language translation). Indeed, the new context of use of this technique requires in particular more complex conversions, formatting and even aggregations, implying a significant adaptation of the technique as described in FIG. 2.

According to the present technique, the neural network is trained by learning, for example by supervised learning, using a learning base constructed in a particular manner, as detailed later in relation to FIG. 2 in various particular embodiments of the proposed technique. More particularly, such a learning base comprises a large number of examples (typically thousands or hundreds of thousands), called samples, of translation from at least one source communication language to at least one target communication language.

In a step 13, the second message M2 is transmitted to the second apparatus. This second message M2 being formatted in the second language associated with this second apparatus, it is perfectly understandable by this second apparatus, and communication is thus established between the first apparatus and the second apparatus.

Of course, several iterations of steps 11 to 13 can be implemented successively, in particular for the implementation of a bidirectional communication (the first apparatus of an iteration becoming the second apparatus of another iteration, and vice versa). According to a particular feature, a batch translation of a plurality of messages can be implemented during steps 11 to 13 (for example via parallel processing techniques implemented by means of an intermediate device based on a multi-core or multi-processor architecture).

Thus, the proposed technique avoids having to develop and maintain a complex code for converting between different communication languages, by using at least one neural network previously trained to deduce and generalize correspondences between these communication languages from correspondence examples provided in one or more learning bases (also sometimes referred to as “learning datasets”). In other words, with the present technique, the business logic is no longer managed algorithmically at a software code, but is moved at one or more learning bases, which offers much more simplicity, flexibility and adaptability to modifications of either one of the communication languages to the user (the code of the neural networks remaining in particular agnostic to the business logic).

The present technique is particularly adapted for implementation in the field of supervision and administration, by an operator, of apparatuses of a telecommunication network. Indeed, as presented in relation to the prior art, such apparatuses (for example radio access network apparatuses of the “RAN” type) often use a proprietary language specific to the apparatus manufacturer that markets it.

Thus, in a particular embodiment of the proposed technique, in at least one iteration of the method for establishing a communication previously described, the message received by the intermediate device is a telemetry message from an apparatus implemented within the infrastructure of a communication network. Such a telemetry message comprises at least one value associated with at least one indicator sent back by the apparatus to the network operator, this indicator being for example associated with an operating state of said apparatus and/or said communication network. This telemetry message received at the intermediate device in the language specific to the apparatus that emitted it is then translated by the intermediate device, by means of one or more neural networks as previously described, into a language compatible with the operator system, and then relayed to this operator (for example to a specific server) so that the latter can exploit the information it contains.

In a complementary or alternative manner, in a particular embodiment of the proposed technique, in at least one iteration of the method for establishing a communication previously described, the message received by the intermediate device is a configuration message emitted by the operator of the communication network (for example via a specific server) and intended for a particular apparatus implemented within the infrastructure of this network. Such a configuration message comprises at least one configuration modification instruction, and possibly one or more associated parameters. This configuration message received at the intermediate device in the language specific to the operator that emitted it is then translated by the intermediate device, by means of one or more neural networks as previously described, into the language specific to the apparatus targeted by the configuration modification request, and then relayed to this apparatus so that the latter can implement the required configuration modification operations.

An extract of an example of a learning base capable of being used to train at least one neural network, so that an operator (here named O) is able to administer the apparatuses from two apparatus manufacturers (here respectively named A and B), in a particular embodiment of the proposed technique, is now described in relation to FIG. 2. In this example, eight samples E1 to E8 are presented.

To make FIG. 2 easier to read, the parts of a sample containing data formatted according to the language of the apparatus manufacturer A are underlined with a solid line, the parts of a sample containing data formatted according to the language of the apparatus manufacturer B are underlined with a dotted line, and the parts of a sample containing data formatted according to the language of the operator O are not underlined.

As can be seen in FIG. 2, each sample associates input data formatted in one language with target data formatted in another language, the target data corresponding to a translation of the input data into this other language. A sample is therefore mainly composed of two parts—a left part corresponding to the input data and a right part corresponding to the input data translated into another language—possibly separated by a separator (the character string “->” in the example of FIG. 2) to facilitate the identification of these two parts by the neural network.

More particularly, in a particular embodiment, the training base comprises samples corresponding to examples of translation of telemetry messages, and samples corresponding to examples of translation of configuration messages.

Thus, if interest is first given to the four samples E1, E2, E3 and E4:
samples E1 and E3 relate to the translation of telemetry messages used to send back indicators from apparatus manufacturers A and B respectively to the operator O;
samples E2 and E4 relate to the translation of configuration messages used to send configuration instructions from the operator O to the apparatus manufacturers A and B respectively.

Samples corresponding to examples of telemetry message translation associate at least one indicator name and indicator value format in a first language with at least one corresponding indicator name and indicator value format in a second language. Thus, if the sample E1 is for example considered, it is seen that the indicator with name “kpi-1” in the system of the apparatus manufacturer A corresponds to the indicator with different name “kpiI” in the system of the operator O, and that apparatus manufacturer A values this indicator in the form of a real number (value “3.1”) while the operator O associates it with an integer (value “3”) in its own system.

The samples corresponding to examples of translation of configuration messages associate at least one configuration command name and a configuration parameter format in a first language with a configuration command name and a configuration parameter format in a second language. Thus, if for example the sample E2 is considered, it is seen that the command with the name “set-foo-threshold” in the system of the operator O corresponds to the command with the different name “foo” in the system of the apparatus manufacturer A, and that while the operator O passes as a parameter of this command an integer (parameter “param1” with value “10”) the corresponding command of the apparatus manufacturer A expects such a parameter or an equivalent parameter under a different name and in the form of a real number (parameter “param−1” with value “10.0”) in order to be able to execute it.

According to a particular feature, a specific value (for example the value “9999”) may be assigned to an indicator (in the case of telemetry message translation) or to a parameter of a configuration instruction (in the case of configuration message translation) in the input data formatted in a first language, to indicate that the indicator or parameter in question has no equivalent in the second language and/or that it must be ignored when translating from the first language to the second language. For example, in the sample E3, the value “9999” is assigned to the name indicator “kpi-III” in the input data, to signify an absence of a corresponding indicator in the target data (for example because such an indicator has no equivalent in the second language, or because for various reasons the operator wishes to voluntarily ignore it).

The preceding examples of samples E1, E2, E3 and E4 are purely illustrative and not limiting, and other types of nomenclature and/or format correspondence may appear in the learning base within the framework of the present technique, for example associations between a single indicator for an actor and a plurality of indicators for another actor (for example when an indicator on the operator side corresponds to the aggregation of several indicators on the apparatus manufacturer side), associations wherein a configuration command for an actor is decomposed into several configuration commands for another actor, associations between distinct formats (for example between integers “0” and “1” on the one hand with respectively character strings “false” and “true” on the other hand), etc.

In a particular embodiment, to supplement or facilitate the learning of the neural network, various additional data are present in the samples of the learning base, in addition to the data relating to the indicators and their values or to the commands and their parameters. Thus, the samples comprise, for example, in their left part and/or in their right part, additional information in addition to the purely telemetric or configuration data, comprising (in an illustrative and non-limiting manner) an actor identifier (for example the name of an apparatus manufacturer or an operator), an apparatus identifier (for example an apparatus model name), an apparatus version, a software identifier associated with an apparatus, a software version associated with an apparatus, a timestamp, a type of task (for example telemetry, configuration, other type of task), etc. According to a particular feature, to facilitate the detection of this additional information by the neural network, a prefix identifying the associated type of information is used within the samples of the learning base. In this case, such a prefix, which can also be called a “tag”, is constant throughout the training base. For example, in the example in FIG. 2, the same prefix “actor-id:” is used throughout the training base to specify that the information immediately following this prefix is an actor identifier (identifier “O” for the operator, “A” for the apparatus manufacturer A, or “B” for the apparatus manufacturer B).

In a particular embodiment, for at least one sample of the learning base associating in this order input data formatted in a first language with target data formatted in a second language (corresponding to the input data translated into the second language), the learning base contains a sample called “mirror” sample associating in this order said target data formatted in said second language with said input data formatted in said first language. According to a particular feature, to each sample present in the learning base corresponds a mirror sample also present in the learning base. For example, the samples E5, E6, E7 and E8 present in the learning base illustrated in FIG. 2 correspond respectively to the mirror samples of the samples E1, E2, E3 and E4 also present in the learning base.

Such an implementation is particularly interesting when it comes to training autoregressive neural networks, which are particularly efficient in the context of the present technique, so that these causal-type networks do not remain in monodirectional use after training (that is to say only able to translate in one direction, from a first language to another, but not in the other direction, from the second language to the first), but that they are on the contrary capable of bidirectional translations or multidirectional translations in the case where the translation is valid for a number greater than two actors.

It is also interesting to note that the present technique allows to manage a context which can be described as “multilingual”, in the sense that translations from at least one language to several other languages (potentially up to several hundred other languages) can be implemented by the same intermediate device.

For example, according to a first implementation, a single neural network can be implemented at the intermediate device, for the translation of many languages (more than two), if the learning base that was used to train it contains examples of messages translated from at least one language to and from a plurality of other languages (that is to say from at least one language to at least two other languages). This is the case in particular for the example of the learning base illustrated in relation to FIG. 2, which is not limited to samples comprising examples of translation between only two languages, but which on the contrary comprises examples of translation of messages in a language specific to the operator O to or from several other languages, that is to say the language associated with the apparatus manufacturer A and the language associated with the apparatus manufacturer B. Such a neural network, and the learning base used to train it, can then be described as “multilingual”.

Alternatively or in a complementary manner, in a second implementation, several neural networks can be implemented at the intermediate device, and more particularly one neural network per pair of languages to be managed (for example a first neural network for translation between the operator O and the apparatus manufacturer A, a second neural network for translation between the operator O and the apparatus manufacturer B, possibly a third neural network for translation between the apparatus manufacturer A and the apparatus manufacturer B, etc.). In this case, each neural network is trained independently of the other neural networks, by means of a learning base that is specific thereto and that contains only associations between the two predefined languages to be processed by the considered neural network, and which can therefore be described as “bilingual”. It may be interesting to note that a multilingual learning base for training a single neural network, as presented in relation to the first implementation previously described, can for example be obtained by concatenating several bilingual learning bases.

According to another aspect, the proposed technique also relates to an intermediate device capable of carrying out the method previously described in any of its embodiments, for establishing a communication between two apparatuses of a communication network. More particularly, such a device according to the present technique comprises:
means for receiving, from one of said two apparatuses, referred to as first apparatus, a first message which is formatted in a first language associated with said first apparatus;
means for generating, from said first message, a second message which is formatted in a second language associated with the other one of said two apparatuses, referred to as second apparatus, said second message corresponding to a translation of said first message into said second language, said generation being implemented by means of at least one neural network;
means for transmitting said second message to said second apparatus.

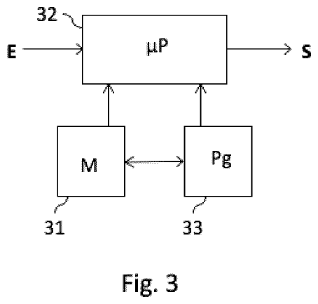

FIG. 3 schematically and simplifiedly represents the structure of such a device, in a particular embodiment. The intermediate device according to the proposed technique comprises for example a memory 31 consisting of a buffer memory M, a processing unit 32, equipped for example with a microprocessor μP, and controlled by the computer program Pg 33, implementing steps of the method for establishing communication between two apparatuses in a communication network according to at least one embodiment of the development. To this end, the intermediate device also comprises at least one communication interface (for example an Ethernet communication interface), allowing it to receive and emit messages from and to other apparatuses present in the communication network, and at least one message translation neural network.

Upon initialization, the code instructions of the computer program 33 are loaded into the buffer memory before being executed by the processor of the processing unit 32. The processing unit 32 receives as input E, for example, a first message from a first apparatus of the communication network, this first message being formatted in a first language associated with said first apparatus.

The microprocessor of the processing unit 32 then performs the steps of the method for establishing a communication, according to the instructions of the computer program 33. More particularly, the first message received at input E is provided as input to at least one neural network implemented by the processing unit 32 and previously trained to translate data formatted in at least one language into data formatted in at least one other language. From the first message formatted in the first language, the neural network more particularly generates a second message corresponding to a translation of the first message into a second language associated with a second apparatus of the communication network. This second message is then transmitted by the processing unit 32 at the output S to the second apparatus, for use.

1. A method for establishing a communication between two apparatuses in a communication network, the method comprising, in an intermediate device, at least one iteration of the following for the implementation of the communication:
receiving, from one of the two apparatuses, referred to as first apparatus, a first message which is formatted in a first language associated with the first apparatus;
generating, from the first message, a second message which is formatted in a second language associated with the other one of the two apparatuses, referred to as second apparatus, the second message corresponding to a translation of the first message into the second language, the generation being implemented by means of at least one artificial neural network; and
transmitting the second message to the second apparatus.

2. The method according to claim 1, wherein the first message is a message associated with a telemetry task, the first message comprising at least one name and one value associated with at least one indicator sent back by the first apparatus, the at least one indicator being associated with an operating state of the first apparatus and/or the communication network.

3. The method according to claim 2, wherein the second message comprises at least a translation of the name into the second language and/or a conversion of the value into a corresponding indicator value format of the second language.

4. The method according to claim 1, wherein the first message is a message associated with a configuration task, the first message comprising at least one configuration modification instruction of the second apparatus emitted by the first apparatus to the second apparatus.

5. The method according to claim 4, wherein the second message comprises at least one translation of the instruction into the second language and/or a conversion of at least one parameter associated with the instructions into a corresponding configuration parameter format of the second language.

6. The method according to claim 1, wherein the at least one artificial neural network is a transformer-based network.

7. The method according to claim 1, wherein the at least one artificial neural network is trained by learning, by means of at least one learning base comprising a plurality of samples associating in this order input data formatted in the first language with target data formatted in the second language, the target data corresponding to a translation of the input data into the second language.

8. The method according to claim 7, wherein for each sample of the plurality of samples, the at least one learning base comprises a sample called a mirror sample associating in this order the target data formatted in the second language with the input data formatted in the first language.

9. The method according to claim 7, wherein the at least one learning base further comprises a plurality of samples associating data formatted in the first language and/or the second language with translated data formatted in at least one other language different from the first language and the second language.

10. The method according to claim 7, wherein the samples comprise at least one association belonging to a group comprising:
a telemetry type association, associating at least one indicator name and one indicator value format in the first language with at least one corresponding indicator name and one corresponding indicator value format in the second language; and
a configuration type association, associating at least one configuration command name and one configuration parameter format in the first language with at least one corresponding configuration command name and one corresponding configuration parameter format in the second language.

11. The method according to claim 10, wherein a specific indicator and/or parameter value in the input data is respectively representative of an absence of a corresponding indicator and/or parameter in the target data.

12. The method according to claim 10, wherein the samples further comprise, in at least one of the input data and the target data, information belonging to a group comprising:
an actor identifier associated with an apparatus;
an apparatus identifier;
an apparatus version;
a software identifier associated with an apparatus;
a software version associated with an apparatus;
a timestamp; and
a type of task.

13. The method according to claim 12, wherein the information is preceded by a prefix identifying an associated type of information, the prefix being, for a given type of information, constant throughout the learning base.

14. A device for establishing communication between two apparatuses in a communication network, the device comprising:
means for receiving, from one of the two apparatuses, referred to as first apparatus, a first message which is formatted in a first language associated with the first apparatus;
means for generating, from the first message, a second message which is formatted in a second language associated with the other one of the two apparatuses, referred to as second apparatus, the second message corresponding to a translation of the first message into the second language, the generation being implemented by means of at least one artificial neural network; and
means for transmitting the second message to the second apparatus.

15. A processing circuit comprising a processor and a memory, the memory storing program code instructions of a computer program downloadable from a communication network and/or stored on a non-transitory computer-readable medium and/or executable by the processor, for executing the method according to claim 1, when executed by the processor.
